(19) United States
(12) Patent Application Publication
(10) Pub. No.: US 2005/0057025 A1
(43) Pub. Date: Mar. 17, 2005

(54) Side airbag for a vehicle

(76) Inventor: Volker Hofmann, Frankfurt (DE)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/883,838

(22) Filed: Jul. 6, 2004

(30) Foreign Application Priority Data
Sep. 16, 2003 (DE) 103 42 754.6

(51) Int. Cl. B60R 21/24; B60R 21/22

(52) U.S. Cl. 280/730.2; 280/729

(57) ABSTRACT

An airbag, in particular a side airbag, has a primary chamber, which can be connected with a gas source, and at least one secondary chamber which is connected to the primary chamber. The primary chamber is inflated after the release of the airbag and used as an impact protection. The secondary chamber is designed so that, in the case of an external force due to an impact onto the primary chamber, it receives at least part of the gas contained in the primary chamber and, once the external force onto the primary chamber has been discontinued or reduced, it redirects this part of the gas into the primary chamber.

### FIELD OF THE INVENTION

The invention relates to an airbag and an airbag module, in particular for a side airbag for a vehicle.

### BACKGROUND OF THE INVENTION

Side airbags are well known in the prior art. DE 198 24 601 C2 describes a side airbag with two chambers, whereby an overflow of gas from the first into the second chamber is only made possible if in the first chamber a predetermined pressure is achieved as a result of an impact of a vehicle occupant with the airbag. In the case of an impact of a vehicle occupant on the airbag, the airbag displays sufficient cushioning to be able to absorb the energy of the striking vehicle occupant or to be able to “slowly” brake the striking vehicle occupant. The problem is that in the case of a repeated impact on the airbag, e.g. in the case of a vehicle rolling over multiple times, the protective effect of the first chamber of the airbag is reduced due to the gas volume which has previously flowed over into the second chamber. This type of airbag thus is only partly suitable for a multiple impact or a repetitive “cushioning” of a vehicle occupant.

### SUMMARY OF THE INVENTION

There is provided in accordance with the present invention an airbag, in particular a side or curtain airbag, comprising at least a primary chamber or protection chamber, which can be connected with a gas source, preferably a gas supply device, for instance an essentially elastic tube or hose, and at least one secondary chamber or working chamber, which is in gas flow communication with the primary chamber. A side airbag comprises at least a primary chamber, which can be connected with a gas source, preferably a gas supply device, and at least a secondary chamber that is connected to the primary chamber, whereby the primary chamber is designed so that it is inflated after the release of the airbag and used as an impact protection, and whereby the secondary chamber is designed so that, in the case of an external force due to an impact onto the primary chamber, it receives at least part of the gas of the primary chamber and, once the external force onto the primary chamber has been discontinued or reduced, it redirects this part of the gas into the primary chamber.

### BRIEF DESCRIPTION OF THE DRAWINGS

FIG. 1 is a side elevation view of an airbag according to a first embodiment of the invention.

FIG. 2 is a side elevation view of an airbag according a second embodiment of the invention.

FIG. 3 shows a further embodiment of a secondary chamber of an airbag according to the invention.

FIGS. 4A, 4B and 4C are cross sections of the airbag of FIG. 1 taken along line A-A of FIG. 1 prior to, during and after the impact of a vehicle occupant.

### DETAILED DESCRIPTION OF THE INVENTION

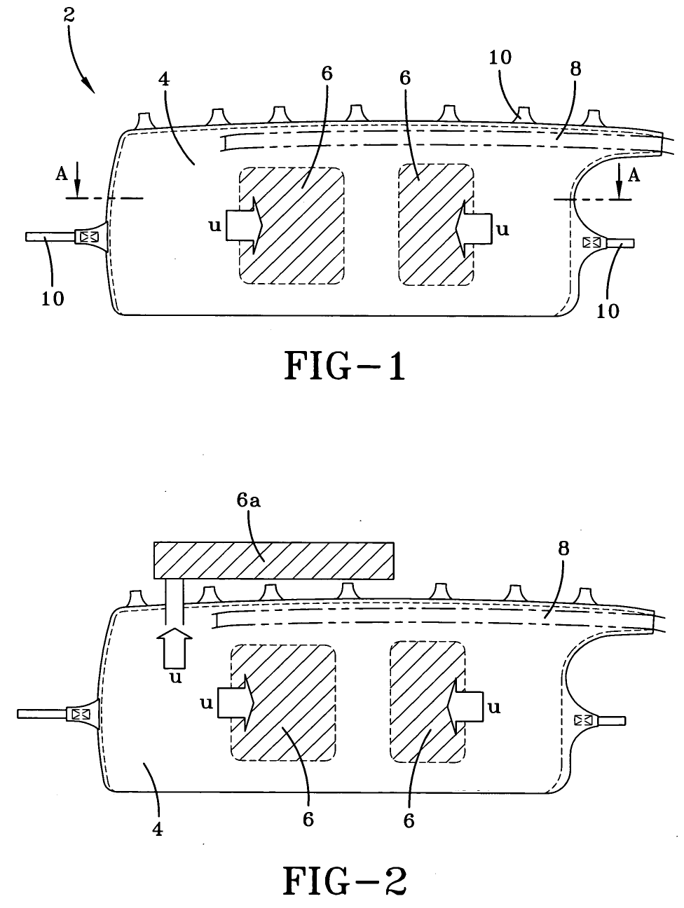

The airbag 2 shown in FIG. 1 has a primary chamber 4 and two secondary chambers 6. In this embodiment the secondary chambers are integral with of the airbag. The primary chamber 4 is a protective chamber for the protection of a vehicle occupant upon impact. The two secondary chambers 6 are used as working or function chambers for receiving a volume of gas. To this effect, preferably merely one secondary chamber 6 or several can be foreseen. The secondary chambers 6 are designed to be readjusted for a volume change, to redirect part of the (overflowing) gas into the primary chamber 4 after the discontinuation or reduction of the external force onto the primary chamber. Due to the readjustment ability of the secondary chambers 6 the part of the gas that has overflowed can be advantageously redirected into the primary chamber in an operationally safe manner. The readjustment ability or flexibility of the secondary chambers can be provided by corresponding material characteristics. By means of a gas supply device 8, for instance a flexible hose provided with openings, during the inflation of the airbag gas is directed into the primary chamber 4 of the airbag 2. In this manner the airbag 2 unfolds and extends along a side region of a vehicle, so that the airbag 2 is still only connected or fastened to the vehicle frame by fastening means 10, e.g. by loops or fastening straps.

The secondary chamber 6 may be an integral part of the primary chamber 4, or to be embedded in the latter. In other words, the primary and the secondary chambers can be designed from the same material or as one piece. The secondary chamber 6 thus represents merely a part or a region of the primary chamber, which in the inflated state of the primary chamber and under the exertion of a force upon the latter can receive at least a part of the gas volume of the primary chamber. It would also be conceivable, however, to arrange the secondary chamber 6 within the primary chamber 4 in a region, which is not subject to an impact by a vehicle occupant.

The secondary chamber 6 is preferably formed by fibers woven into the fabric of the primary chamber 4, designed to be preferably flexible or repeatably adjustable or elastic. In the primary chamber fibers are thus worked or woven in, which the primary chamber contracts in these regions, i.e. guides the two walls located in the expansion plane of the airbag essentially together, to create a secondary chamber. This secondary chamber thus displays a lower surface volume (seen from the expansion plane) than the primary chamber. In this manner the airbag can be manufactured in a simple and cost-effective manner.

A secondary chamber 6 preferably comprises a repeatably adjustable web structure at least partly adjacent to the periphery of the primary chamber 4. This type of web structure is arranged in regions of the primary chamber, which are to make up the secondary chamber. The secondary chamber is thus created within the primary chamber. The web structure can preferably be adjacent to the outside of the periphery of the primary chamber, but a positioning of the web structure on the internal wall of the primary chamber is also conceivable, whereby it is then connected to the primary chamber in this region, e.g. by means of gluing.

As is shown in FIG. 2, a secondary chamber 6a can alternatively be arranged external of the primary chamber 4. It is conceivable to provide a combination of one or several external secondary chambers 6a and of secondary chambers 6 arranged within the primary chamber 4. Due to the provision of the secondary chamber 6a separated from the primary chamber 4, the secondary chamber 6a can be arranged in an advantageous region of the vehicle. It would also be conceivable to foresee just one joint secondary chamber 6a for several airbags 2, arranged in a correspondingly separate manner from in each case the primary chambers 4 and jointly used for several airbags or primary chambers in the vehicle. In a further preferred embodiment the secondary chamber is located external of the primary chamber. In this manner, the secondary chamber can be advantageously distanced from the primary chamber in a region in the vehicle, which is not in a direct context with the airbag or the primary chamber, i.e. the secondary chamber can for instance be arranged in the vehicle frame or else in a more distanced region.

The secondary chamber, or chambers, 6, 6a may comprise contraction means. Due to the contraction means of a secondary chamber it is advantageously achieved that the latter essentially “contracts”. In the absence of an external force on the primary chamber 4, the secondary chamber 6 advantageously has a very low volume, which is preferably approximately zero. The secondary chamber is thus able to receive a large volume of overflowing gas in the event of an impact. The contraction means of the secondary chamber are preferably internal, elastic or flexible bands 7, which extend preferably essentially perpendicular to the expansion plane of the airbag. The contraction means are thus arranged within the secondary chamber and guide the two walls of the secondary chamber positioned in the expansion plane so that they are essentially superimposed, and a low volume is enclosed in the secondary chamber. By arranging the elastic or flexible bands to be essentially perpendicular to the expansion plane of the airbag, an effective volume reduction of the secondary chamber can be advantageously achieved. The expansion plane of the airbag is essentially the plane in which the airbag extends in the case of its release, i.e. in the case of a side airbag a plane that is essentially parallel to a window or door surface of a vehicle.

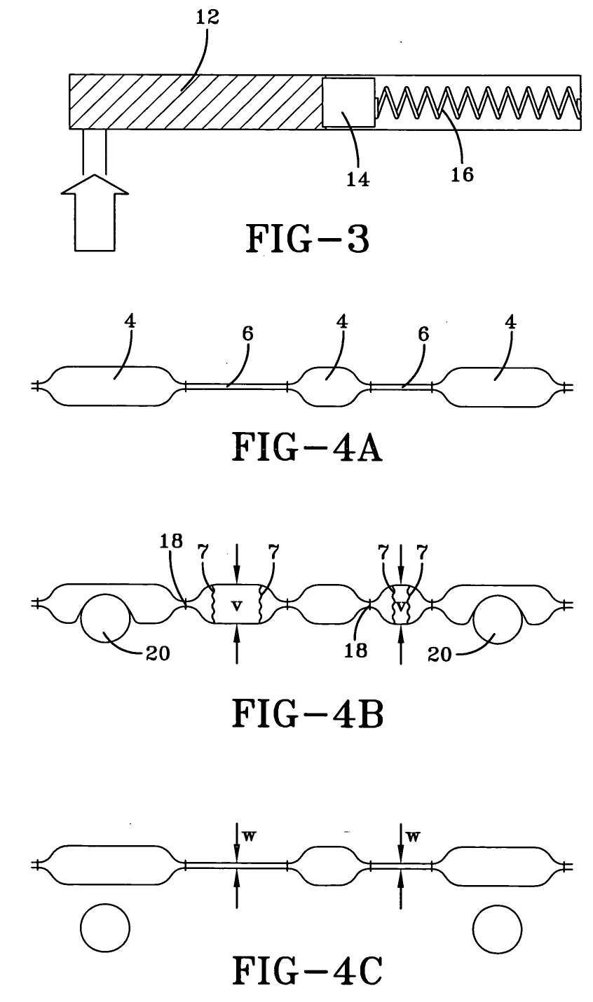

To this effect a secondary chamber 6, 6a is foreseen as an essentially bellows-shaped, elastic element, which extends from the primary chamber 4 into the secondary chamber 6, 6a during the overflowing of the gas from the primary chamber as indicated in FIGS. 1 and 2 by arrows U. Alternatively, a secondary chamber 6, 6a that is a volume or pressure-adjusting unit can also be in the form of a cylinder 12, as shown in FIG. 3. The cylinder and comprises a volume- or pressure-adjusting unit, preferably in the form of a spring-loaded piston, which is designed to adjust the volume and/or pressure of the gas situated in the secondary chamber. Within the cylinder 12 a piston 14 is located, which is biased by a spring 16. During the flowing of gas from the primary chamber 4 into the secondary chamber 6, 6a the piston 14 is pushed against the spring force of the spring 16, so that the volume of the gas-receiving space of the cylinder 12 is increased. During the reduction or discontinuation of the external force on the primary chamber, the piston 14, as a result of the spring force of the spring 16, pushes the gas that has overflowed from the primary chamber 4 into the secondary chamber 6, 6a back into the primary chamber 4. After the completion of this process, the airbag 2 returns to its beginning or starting state, i.e. the primary chamber 4 is inflated to its maximum with gas once again. With reference to the volume and the internal pressure, this type of unit displays the same characteristics as a corresponding elastic chamber, i.e. in the case of an increased volume in the secondary chamber, an increase in internal pressure is also indicated here, so that if the external force on the primary chamber is discontinued due to pressure balancing, the part of the gas that has overflowed is redirected from the second into the primary chamber.

The primary chamber 4 is designed so that it is inflated after the release of the airbag and used as an impact protection, and the secondary chamber 6, 6a is designed so that, in the case of an external force due to an impact onto the primary chamber, it receives at least part of the gas of the primary chamber and, once the external force onto the primary chamber has been discontinued or reduced, it redirects the gas into the latter. To this effect the two chambers are essentially sealed in a gas tight manner with reference to their surroundings.

Due to the provision of multiple chambers 4; 6, 6a, during the inflation of the airbag 2 with gas it can be ensured that initially a primary chamber is inflated. The secondary chamber can at the same time be at least partially inflated, however a non-inflation is also possible. Valve means, which can preferably be foreseen between the primary and the secondary chamber, ensure that initially the primary chamber is completely or more rapidly inflated with gas. In the case of a crash, the primary chamber thus provides in an even shorter space of time the required protection and will be arranged in the location of the head of the vehicle occupant. In the case of an impact of the vehicle occupant on to the primary chamber, the secondary chamber receives at least part of the gas of the primary chamber to relieve the latter. In this manner the vehicle occupant hitting the primary chamber can be advantageously slowly braked. Due to the provision according to the invention of a secondary chamber which is designed to redirect at least part of the gas present in the secondary chamber after the external force onto the primary chamber has been discontinued or reduced, the airbag is advantageously suited for situations in which a multiple impact of the vehicle occupant onto the airbag or the primary chamber takes place. In this manner a constant protection effect is advantageously achieved in multiple or repeated impacts, for instance in a multiple rollover of the vehicle. This is achieved in that initially the primary chamber is inflated with gas in the event of a crash by means of a gas generator. In this state the secondary chamber of the airbag can be separated from the primary chamber in such a manner that the secondary chamber is initially not or else only slightly inflated with gas. Alternatively, however, the secondary chamber can also be inflated with gas. If then a vehicle occupant impacts upon the airbag or the primary chamber of the airbag, the internal pressure of the primary chamber increases and the gas of the primary chamber flows at least partly into the secondary chamber which thus increases in volume. In this manner the internal pressure in the primary chamber can be reduced during the impact of the vehicle occupant onto the airbag, whereby the impact is cushioned. By receiving the overflowing gas volume in the secondary chamber it is thus possible to cushion an impact without providing a flow of gas into the surroundings. By removing the vehicle occupant from the primary chamber, i.e. during a discontinuation or a reduction of the external force on the primary chamber, the internal pressure in the latter is once again reduced, so that the overflowing gas present in the secondary chamber can be redirected into the primary chamber. The primary chamber is thus once again in its beginning or starting state, i.e. it is inflated with its original gas volume and thus able to offer protection from further impacts.

The functioning of an airbag according to the invention is shown in FIGS. 4A, 4B and 4C. FIGS. 4A, 4B and 4C are cross sections of the airbag of FIG. 1 taken along line A-A of FIG. 1 prior to, during and after the impact of a vehicle occupant with the airbag. As shown in FIG. 4A, prior to the impact, only the primary chamber 4 is inflated with gas. The secondary chambers 6 are almost devoid of gas. In this embodiment the secondary chamber 6 is created by separating a region from the primary chamber 4. This is carried out e.g. by providing a (welding) seam 18, whereby the secondary chamber 6 is not completely closed off from the primary chamber 4 in a gastight manner, but a gas overflow from the primary chamber 4 to the secondary chamber 6 is possible. As shown in FIG. 4B, during the impact of a vehicle occupant 20 onto the primary chamber 4, at least part of the gas from the primary chamber 4 flows over into the secondary chambers 6, so that the secondary chambers correspondingly expand and increase in volume, as is shown by the arrows labeled V. In this manner a beneficial cushioning characteristic of the primary chamber 4 can advantageously be foreseen to absorb the energy of the striking vehicle occupant or to slowly brake the striking vehicle occupant. After distancing the vehicle occupant 20 from the primary chamber 4, i.e. after the discontinuation or reduction of the external force on the primary chamber 4, the secondary chamber 6 reduces its volume, as shown in FIG. 4C, as indicated by the arrows labeled W on the basis of its material or its constructive characteristics, so that the gas that has overflowed from the primary chamber 4 into the secondary chambers 6 is redirected into the primary chamber 4. In this state, the primary chamber 4 or the airbag 2 is back to its starting state, so that the airbag is able to cushion or absorb a further impact. As a result an airbag 2 is foreseen which also retains its original protective function in a multiple impact situation.

The primary 4 and the secondary chambers 6, 6a may comprise different materials, whereby the secondary chamber preferably comprises an elastic material. The primary chamber preferably comprises an essentially silicon or PU coated fabric. This type of fabric ensures an almost complete gas tight sealing of the airbag, whereby particularly long periods of time of the inflated airbag can be achieved. The secondary chamber preferably comprises an elastomer, for instance a rubber or rubber-type material, which also ensures an almost complete gas tight sealing of the secondary chamber while maintaining a high level of elasticity.

According to the invention, an airbag module, in particular for a side or curtain airbag, is provided, comprising an airbag according to the invention, a gas generator and a gas source, preferably a gas supply device, which connects the airbag and the gas generator. In this manner a particularly safe airbag module is foreseen, which maintains its protective effect even in multiple impacts.

While the invention has been described in accordance with its preferred embodiments, it should be recognized that changes and modifications might be made therein without departing from the scope of the appended claims.

1. A side airbag comprising at least a primary chamber that can be connected in a gas flow manner with a gas source and at least a secondary chamber that is connected in a gas flow manner to the primary chamber,
whereby the primary chamber is designed so that it is inflated after the release of the airbag and used as an impact protection, and
whereby the at least one secondary chamber is designed so that, in the case of an external force due to an impact onto the primary chamber the at least one secondary chamber receives at least part of the gas of the primary chamber and, once the external force onto the primary chamber has been discontinued or reduced, the at least one secondary chamber redirects this part of the gas back into the primary chamber.

2. The side airbag according to claim 1, wherein the at least one secondary chamber can be readjusted for a volume change, to redirect the part of the gas into the primary chamber after the discontinuation or reduction of the external force onto the latter.

3. The side airbag according to claim 1, wherein the at least one secondary chamber comprises contraction means.

4. The side airbag according claim 2, wherein the at least one secondary chamber comprises contraction means.

5. The side airbag according to claim 3, wherein the contraction means of at least one secondary chamber are internal, elastic bands, which extend essentially perpendicular to the expansion plane of the airbag.

6. The side airbag according to claim 4, wherein the contraction means of at least one secondary chamber are internal elastic bands that extend essentially perpendicular to the expansion plane of the airbag.

7. The side airbag according to claim 1, wherein the primary and at least one secondary chamber comprise different materials, at least one secondary chamber comprising an elastic material.

8. The side airbag according to claim 1, wherein at least one secondary chamber is integral with the airbag.

9. The side airbag according to claim 8, wherein at least one secondary chamber comprises fibers woven into the fabric of the primary chamber, designed to be preferably flexible or readjustable.

10. The side airbag according to claim 8, wherein at least one secondary chamber comprises an elastic web structure at least partly adjacent to the periphery of the primary chamber.

11. The side airbag according to claim 9, wherein at least one secondary chamber comprises an elastic web structure at least partly adjacent to the periphery of the primary chamber.

12. The side airbag according to claim 1, wherein at least one secondary chamber is arranged separate from the primary chamber.

13. The side airbag according to claim 12, wherein the secondary chamber is a cylinder comprising a volume or pressure adjusting unit that adjusts the volume and/or pressure of the gas situated in the secondary chamber.

14. The side airbag according to claim 13, wherein the volume or pressure adjusting unit is a spring-loaded piston.

15. The side airbag of claim 1 assembled with a gas generator and a gas supply device that connects the airbag and the gas generator in a gas flow manner.
